(19) United States
(12) Patent Application Publication
(10) Pub. No.: US 2026/0014820 A1
(43) Pub. Date: Jan. 15, 2026

(54) PNEUMATIC TIRE

(71) Applicant: Toyo Tire Corporation, Itami-shi, Hyogo (JP)

(72) Inventor: Hiroki Amimoto, Itami-shi (JP)

(73) Assignee: Toyo Tire Corporation, Itami-shi, Hyogo (JP)

(21) Appl. No.: 19/250,949

(22) Filed: Jun. 26, 2025

(30) Foreign Application Priority Data
Jul. 11, 2024 (JP) 2024-111527
Jul. 11, 2024 (JP) 2024-111531
Jul. 11, 2024 (JP) 2024-111557

(51) Int. Cl. B60C 13/02; B60C 11/01

(52) U.S. Cl. CPC B60C 13/02; B60C 11/01

(57) ABSTRACT

A pneumatic tire includes a tread, a side wall, and a bead. The side wall includes side blocks protruding outward in a tire axial direction. Each side block includes at least a main block extending in a tire radial direction. The main block includes a protrusion region having a largest protrusion height in the main block, and an inner inclination region connected with an inward edge of the protrusion region in the tire radial direction. The inner inclination region has a protrusion height that gradually decreases as the inner inclination region extends away from the protrusion region. The protrusion region has a length in the tire radial direction, and the length is equal to or larger than a length of the inner inclination region in the tire radial direction.

### CROSS REFERENCE TO RELATED APPLICATION

This application claims priorities to Japanese Patent Applications Nos. 2024-111527 filed on Jul. 11, 2024, 2024-111531 filed on Jul. 11, 2024, and 2024-111557 filed on Jul. 11, 2024, which are incorporated herein by reference in their entirety including the specification, claims, drawings, and abstract.

### TECHNICAL FIELD

The present disclosure relates to a pneumatic tire.

### BACKGROUND

A pneumatic tire including a tread, a side wall, and a bead are widely known as an off-road tire for use on muddy or sandy ground. JP 2018-52198 A and JP 2023-54401 A each disclose a pneumatic tire including a side wall having a plurality of side blocks protruding outward in the axial direction of the tire. The side blocks disposed on the side wall enable high traction performance, for example.

### SUMMARY

Off-road tires are expected to travel on rocky tracts. There has therefore been a demand for pneumatic tires that can achieve high traction performance when traveling along rocky tracts.

In accordance with an embodiment of the present disclosure, a pneumatic tire includes a tread, a side wall, and a bead. The side wall includes side blocks protruding outward in a tire axial direction. Each side block includes at least a main block extending in a tire radial direction. The main block includes a protrusion region having a largest protrusion height in the main block, and an inner inclination region connected with an inward edge of the protrusion region in the tire radial direction. The inner inclination region has a protrusion height that gradually decreases as the inner inclination region extends away from the protrusion region. The protrusion region has a length in the tire radial direction, and the length in the tire radial direction is equal to or larger than a length of the inner inclination region in the tire radial direction.

The pneumatic tire according to the disclosure achieves high traction performance.

### BRIEF DESCRIPTION OF DRAWINGS

An embodiment of the present disclosure will be described based on the following figures, wherein:

FIG. 1 schematically illustrates an axial cross section of a pneumatic tire according to an example embodiment;

FIG. 2 is a perspective view of the pneumatic tire according to the example embodiment;

FIG. 3 is a side view of the pneumatic tire according to the example embodiment;

FIG. 4 is a projection view of an outward side of the pneumatic tire in the axial direction according to the example embodiment;

FIG. 5 is a cross sectional view taken along line A-A in FIG. 4;

FIG. 6 is a cross sectional view taken along line B-B in FIG. 4;

FIG. 7 is a cross sectional view taken along line C-C in FIG. 4; and

FIG. 8 is a cross sectional view taken along line D-D in FIG. 4.

### DESCRIPTION OF EMBODIMENTS

A pneumatic tire according to an example embodiment of the present disclosure will be described in detail below with reference to the drawings. The embodiment described below is only an example, and the present disclosure is not limited to the embodiment below. The present disclosure further includes selective combinations of elements in a plurality of embodiments and modification examples described below.

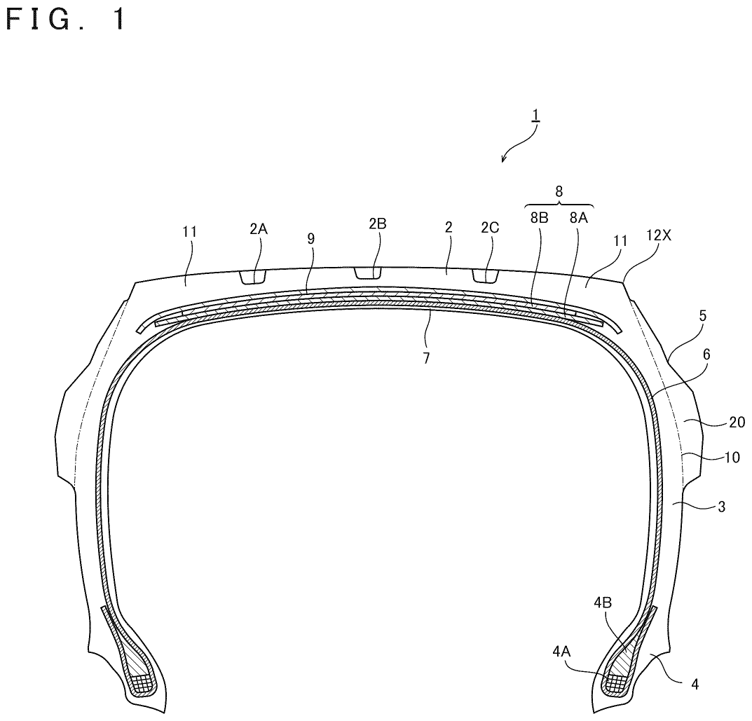

FIG. 1 schematically illustrates an axial cross section of a pneumatic tire 1 according to a present embodiment. As illustrated in FIG. 1, the pneumatic tire 1 includes a tread 2 that comes into contact with a road surface, a side wall 3 forming a tire side face, and a bead 4 fixed to a rim of a wheel. The pneumatic tire 1 is appropriate for a mud-terrain tire (MT tire) or a rugged terrain tire (RT tire) suitable for off-road driving such as muddy-road and rocky-tract driving, for example. The pneumatic tire 1 is mounted, for example, on a light duty truck including a pickup truck, and a sport utility vehicle (SUV), for example.

The mounting direction of the pneumatic tire 1 is not designated with respect to a vehicle, and the pneumatic tire 1 is a tire with point symmetry that allows the tread patterns and shape of the tire side faces to be unchanged regardless of the mounting direction of the tire with respect to the vehicle. The pneumatic tire 1 has tread patterns and tire side face shapes that are symmetrical with respect to the tire equator or center line CL. The tire equator or center line CL refers to a virtual line extending along the tire circumferential direction through the tire axial center of the tread 2.

The tread 2 includes a plurality of blocks and grooves that separate the blocks. The tread 2 includes a plurality of circumferential grooves 2A, 2B, and 2C extending circumferentially of the tire. The tread 2 further includes shoulder blocks 11 on axially opposite sides of the tread 2 that are disposed further axially outward with respect to the circumferential grooves 2A and 2C, respectively.

The side walls 3 are disposed on opposite sides of the tread 2 in the tire axial direction circularly along the tire circumferential direction. The side wall 3 corresponds to a portion of the pneumatic tire 1 that protrudes most outwardly in the tire axial direction, and is gently curved to have a convex shape protruding outward in the tire axial direction. Thus, the side wall 3 has an outer face having a location at which the tire has the maximum width.

The pneumatic tire 1 further includes a side rib 5 on the tire side face adjacent to the tread 2. The side rib 5 is a convex portion protruding axially outward and is circularly formed along the tire circumferential direction. In this embodiment, a region of the tire from the axially outward edge of the top face of the shoulder block 11 facing outward to the side rib 5 is defined as a buttress region, and a region of the tire from the bead 4 to the side rib 5 is defined as the side wall 3.

The tread 2 and the side wall 3 are typically composed of different types of rubber. The buttress region may be composed of the same rubber as that of the tread 2 or of rubber that is different from that of the tread 2.

The bead 4 is disposed inward of the side wall 3 in the tire radial direction, and is secured to the rim of the wheel. The bead 4 includes a bead core 4A and a bead filler 4B. The bead core 4A is a circular member composed of a steel bead wire and extending circumferentially over the entire circumference of the tire, and is embedded in the bead 4. The bead filler 4B is a circular rigid rubber member having a tapered shape extending radially outward of the tire and extending over the entire circumference of the tire.

The pneumatic tire 1 further includes a carcass 6 circumferentially extending between a pair of beads 4, and an inner liner 7 disposed inward of the carcass 6 in the tire radial direction.

The carcass 6 circumferentially extends between the pair of beads 4 and is retained by being folded over around the bead core 4A. The carcass 6 is composed of at least one carcass ply that is composed of a carcass cord made of an organic fiber, coated with coating rubber.

The inner liner 7 covers a tire inner face between the pair of beads 4. The inner liner 7 is composed of an air permeation resistant rubber and has a function to maintain the air pressure of the pneumatic tire 1.

The pneumatic tire 1 further includes a belt 8 disposed further outward with respect to the carcass 6 in the tire radial direction, and a cap ply 9 covering a region further outward with respect to the belt 8 in the tire radial direction. The cap ply 9 has a function to reinforce the belt 8.

The belt 8 is disposed outward of the top portion of the carcass 6 in the tire radial direction in a superimposed manner with the outer circumferential face of the carcass 6. The belt 8 is composed of a belt ply including cords arranged in a direction inclined with respect to the tire circumferential direction, coated with rubber. The material of the cord of the belt 8 is not particularly limited and may be organic fiber such as polyester, rayon, nylon, and aramid, and a metal such as steel, for example. In this embodiment, the belt 8 is composed of two belt plies 8A and 8B. The number of belt plies is not limited, and may be one, or three or greater.

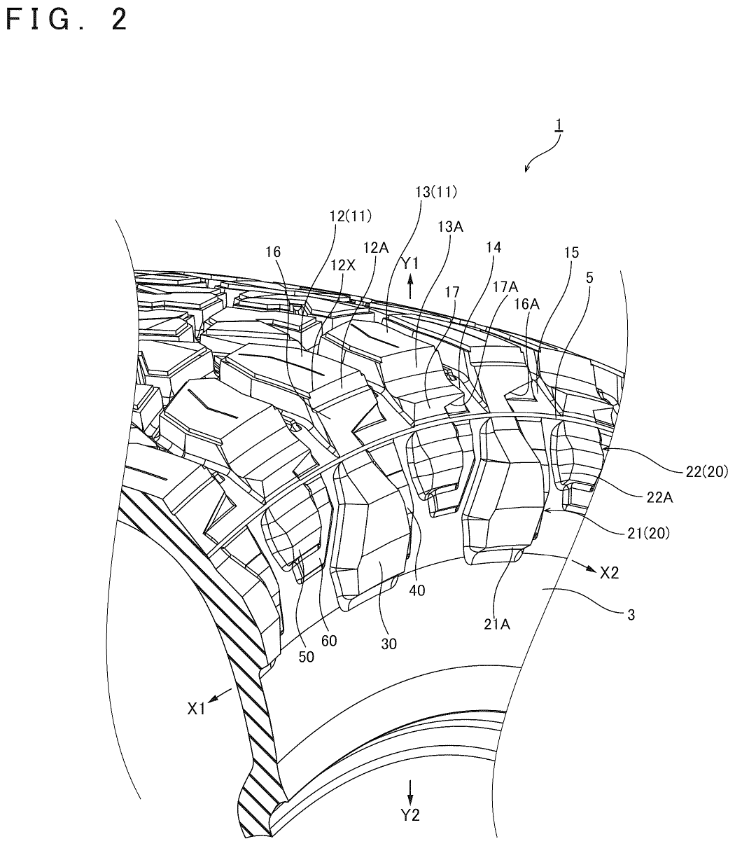

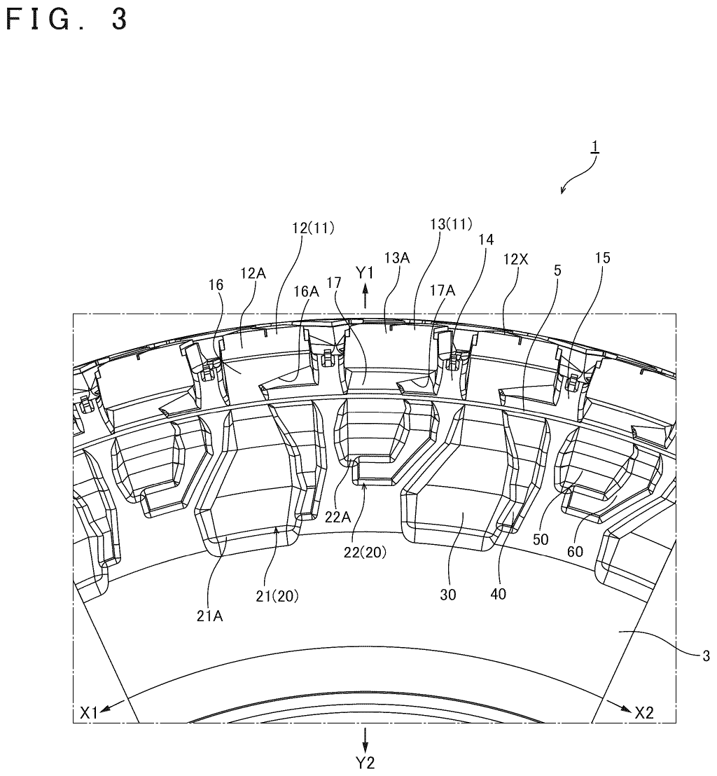

Referring to FIG. 2 and FIG. 3, the shoulder blocks 11, the buttress regions, and the side wall 3 of the pneumatic tire 1 will be described in detail. FIG. 2 is a perspective view of the pneumatic tire 1, and FIG. 3 is a left side view of the pneumatic tire 1. FIG. 2 and FIG. 3 show the shoulder blocks 11, the buttress regions, and the side wall 3 in an enlarged manner. In the following description, a first direction in the tire circumferential direction and a second direction in the tire circumferential direction may be referred to as an “X1 direction” and an “X2 direction”, respectively, as indicated in FIG. 2 and FIG. 3. The direction moving radially outward of the tire and the direction moving radially inward of the tire may be referred to as a “Y1 direction” and a “Y2 direction”, respectively.

### Shoulder Block

As illustrated in FIG. 2 and FIG. 3, the shoulder blocks 11 are disposed on outward portions of the tread 2 (see FIG. 1) in the tire axial direction, which will be referred to as “axially outward portions”. The shoulder blocks 11 include a first shoulder block 12 and a second shoulder block 13 having different shapes. The first shoulder block 12 and the second shoulder block 13 are defined by longitudinal grooves 14 and 15 and are arranged alternately along the tire circumferential direction. The arrangement of the shoulder blocks 11 is not limited to this example, and the block of a single type may be circumferentially arranged at intervals.

In the present embodiment, on the top face of the tread 2, the outward edge of the first shoulder block 12 in the tire axial direction, which will be referred to as the “axially outward edge”, is located further axially outward relative to the axially outward edge of the second shoulder block 13. As such, the axially outward edge of the top face of the tread 2 is composed of a corner portion 12X formed at the axially outward edge of the first shoulder block 12.

### Buttress Region

In the buttress region, a first buttress block 16 and the second buttress block 17 protrude axially outward from side faces 12A and 13A of the first shoulder block 12 and the second shoulder block 13, respectively. The first buttress block 16 and the second buttress block 17 refer to regions, of the blocks protruding axially outward, located further outward with respect to the side rib 5 in the tire radial direction and protruding axially outward beyond a profile line 10 (see FIG. 1). The profile line 10 as used herein refers to a contour line gently connecting the corner portion 12X of the shoulder block 12 at the axial outward edge of the top face of tread 2 and the bead 4 (see FIG. 1) in an axial cross section of the pneumatic tire 1. The profile line 10 is composed of one or more arcs and is defined with partial recesses and projections being excluded.

The first buttress block 16 and the second buttress block 17 disposed on the side faces 12A and 13A of the first shoulder block 12 and the second shoulder block 13, respectively, form recesses and a projections in the tire circumferential direction in the buttress region. While the vehicle is travelling on muddy or sandy ground, these recesses and projections catch mud and stones to achieve high traction performance. The first buttress block 16 and the second buttress block 17 do not normally contact the ground while the vehicle is traveling on flat roads.

In the present embodiment, the first buttress block 16 and the second buttress block 17 have inward edges in the tire radial direction, which will be referred to as “radially inward edges”, that are connected with the side rib 5. However, the radially inward edges of the first buttress block 16 and the second buttress block 17 may be unconnected with the side rib 5.

The first buttress block 16 has an outward edge in the tire radial direction, which will be referred to as the “radially outward edge” located further radially outward (further toward Y1 direction) with respect to a radially outward edge of the second buttress block 17. In other words, the length of the first buttress block 16 in the tire radial direction is greater than the length of the second buttress block 17 in the tire radial direction. This configuration facilitates achievement of high traction performance. The radial length of the buttress block 16 is 1.2 times or greater the radial length of the second buttress block 17, and may be 1.5 times or greater, for example.

The first buttress block 16 has a recess portion 16A in a radially inward portion. The recess portion 16A is an indentation disposed at a circumferential edge of the first buttress block 16 in the X2 direction and formed toward the X1 direction. During travelling on the muddy or sandy ground, for example, the recess portion 16A catches mud and sand.

This configuration facilitates achievement of high traction performance.

The length of the recess portion 16A in the tire radial direction, or the radial length of the recess portion 16A, decreases toward the X1 direction. The radial length of the recess 16A is 10% or more and 60% or less of the radial length of the first buttress block 16 at the circumferential edge of the recess 16A on the X1 side, for example, and is 30% or more and 80% or less of the radial length of the first buttress block 16 at the circumferential edge of the recess 16A on the X2 side, for example. The length of the recess 16A in the tire circumferential direction is 20% or more and 80% or less of the length of the first buttress block 16 in the tire circumferential direction.

Similar to the first buttress block 16, the second buttress block 17 has a recess portion 17A in a radially inward portion. The recess portion 17A is an indentation disposed at a circumferential edge of the second buttress block 17 on the X2 side and formed toward the X1 direction. During travel on muddy or sandy roads, for example, the recess portion 17A, similar to the recess portion 16A, catches mud and sand. This configuration facilitates achievement of high traction performance.

The recess portion 17A has a shape that is similar to that of the recess portion 16A and is smaller than the recess 16A. The radial length of the recess portion 17A is, for example, 10% or more and 70% or less of the radial length of the second buttress block 17 at a circumferential edge of the recess portion 17A on the X1 side, and is 30% or more and 95% or less of the radial length of the second buttress block 17 at a circumferential edge of the recess portion 17A on the X2 side. The circumferential length of the recess portion 17A is, for example, 10% or more and 70% or less of the circumferential length of the second buttress block 17.

### Side Wall

As illustrated in FIG. 2 and FIG. 3, a plurality of side blocks 20 protruding outward in the tire axial direction are disposed on the side wall 3. Here, the side block 20 refers to a region, of the blocks protruding outward in the tire axial direction, located further inward with respect to the side rib 5 in the tire radial direction and protruding outward in the tire axial direction from the profile line 10 (see FIG. 1). The side blocks 20 include a first side block 21 and a second side block 22 having different shapes. The first side block 21 and the second side block 22 are alternately arranged in the tire circumferential direction.

The first side block 21 is disposed at a location where the first side block 21 is aligned with the first buttress block 16 in the tire radial direction. A radially inward portion of the first side block 21 is disposed at a location where the radially inward portion is aligned with the longitudinal groove 14 and the second buttress block 17, in addition to the first buttress block 16, in the tire radial direction. Thus, the radially inward portion of the first side block 21 protrudes in the X1 direction, and has a length in the tire circumferential direction or a circumferential length, which is larger than the circumferential length of a radially outward region of the first side block 21. The circumferential length of the first side block 21 at the radially outward edge is substantially the same as the circumferential length of the first buttress block 16 at the radially inward edge.

The first side block 21 may have a block edge that is normal to the profile line 10 or that is inclined to sequentially lower the height of the block. In the present embodiment, the block edge of the first side block 21 has a slope face 21A that is inclined to sequentially lower the height of the block, and that is curved in the vicinity of the boundary with the profile line 10.

The first side block 21 includes a single first main block 30 extending in the tire radial direction and a single first sub block 40 extending in the tire radial direction, which are connected and integrated. The first main block 30 protrudes the furthest of the side blocks 20, and has the maximum protrusion height that is larger than that of a second main block 50 which will be described below. The first sub block 40 is disposed on a side of the first main block 30 in the X2 direction, and has a protrusion height that is smaller than the protrusion height of the first main block 30. As such, a step extends along the tire radial direction at the boundary between the first main block 30 and the first sub block 40. The first sub block 40 serves to reinforce the strength of the first main block 30. The first sub block 40 increases the strength and durability of the first main block 30 and more notably achieves advantages of the first main block 30 that will be described below.

The first main block 30 has a radially outward edge that is connected with the side rib 5. The first main block 30 is disposed opposite the first buttress block 16 with the side rib 5 being interposed between the first main block 30 and the first buttress block 16. The circumferential length of the first main block 30 at the radially outward edge is equal to the circumferential length of a portion of the first buttress block 16 at the radially inward edge where the recess portion 16A is not formed.

The first sub block 40 has a radially outward edge that is connected with the side rib 5, and the first sub block 40 is located opposite the recess portion 16A disposed in the first buttress block 16, with the side rib 5 being interposed between the first sub block 40 and the recess portion 16A.

The second side block 22 is disposed at a location where the second side block 22 is aligned with the second buttress block 17 in the tire radial direction. The second side block 22 is not disposed at a location where the second side block 22 is aligned with the first buttress block 16 and the longitudinal grooves 14 and 15 in the tire radial direction. A radially inward portion of the second side block 22 has a decreasing circumferential length as the second side block 22 extends toward the Y2 direction. The circumferential length of the second side block 22 at a radially outward edge is substantially the same as the circumferential length of the second buttress block 17 at a radially inward edge, for example.

The second side block 22 may have a block edge that is normal to the profile line 10 or that is inclined to sequentially lower the height of the block, similar to the block edge of the first side block 21. In the present embodiment, the block edge of the second side block 22 has a slope face 22A that is inclined to sequentially lower the height of the block and that is curved near the boundary with the profile line 10.

The second side block 22 includes a single second main block 50 extending in the tire radial direction and a single second sub block 60 extending in the tire radial direction, which are connected and integrated. The second sub block 60 is disposed on a side of the second main block 50 toward the X2 direction, and has a protrusion height that is smaller than the protrusion height of the second main block 50. As such, a step extends along the tire radial direction at the boundary between the second main block 50 and the second sub block 60. The second sub block 60, similar to the first sub block 40, serves to reinforce the strength of the second main block 50. The second sub block 60 increases the strength and durability of the second main block 50 and more notably achieves advantages of the second main block 50 that will be described below. As will be described in detail below, the maximum protrusion height of the second main block 50 is smaller than the maximum protrusion height of the first main block 30.

The second main block 50 has a radially outward edge that is connected with the side rib 5. The second main block 50 is disposed opposite the second buttress block 17 with the side rib 5 interposed between the second main block 50 and the second buttress block 17. The circumferential length of the second main block 50 at the radially outward edge is equal to the circumferential length of a portion of the second buttress block 17 at the radially inward edge where the recess portion 17A is not formed.

The second sub block 60 has a radially outward edge that is connected with the side rib 5, and the second sub block 60 is disposed opposite the recess portion 17A disposed in the second buttress block 17, with the side rib 5 being interposed between the second sub block 60 and the recess portion 17A.

The radial length of the first main block 30 is larger than the radial length of the second main block 50. Thus, the radially inward edge of the first main block 30 is located further in the Y2 direction than the radially inward edge of the second main block 50. This configuration creates a region where the second main block 50 is not disposed, between the radially inward regions of two of the first main blocks 30 adjacent to each other in the tire circumferential direction. As described above, the maximum protrusion height of the first main block 30 is larger than the maximum protrusion height of the second main block 50. This configuration enables such a region to easily catch rocks during travel on rocky tracts, thereby achieving high traction performance during travel on the rocky tracts.

The length of the first main block 30 in the tire radial direction may be 1.2 times or more of the length of the second main block 50 in the tire radial direction, or may be 1.5 times or more of the length of the second main block 50 in the tire radial direction. This configuration allows a larger region where the second main block 50 is not disposed to be formed between two of the first main blocks 30 adjacent to each other in the tire circumferential direction, enabling the region to catch rocks more easily during travel on rocky tracts, to thereby achieve higher traction performance.

The length of the first main block 30 in the tire radial direction may be 3.0 times or less of the length of the second main block 50 in the tire radial direction, or may be 2.5 times or less of the length of the second main block 50 in the tire radial direction. This configuration increases the area of the side wall 3 covered with the side blocks 20 to thereby increase cut resistance of the side wall 3. Therefore, the length of the first main block 30 in the tire radial direction may be 1.2 times or more and 3.0 times or less of the length of the second main block 50 in the tire radial direction, or may be between 1.5 and 2.5 times of the length of the second main block 50 in the tire radial direction.

As described above, the radially inward portion of the first main block 30 protrudes toward the X1 direction. Here, the first main block 30 may be disposed in such a manner that the first main block 30 is not aligned with the second main block 50 in the tire radial direction. This configuration allows creation of a larger region where the second main block 50 is not disposed, between two of the first main blocks 30 adjacent to each other in the tire circumferential direction, enabling that region to catch rocks more easily. This results in achieving of higher traction performance during travel on rocky tracts. In other words, the configuration including the first main block 30 and the second main block 50 disposed to be aligned with each other in the tire radial direction may make it more difficult to catch rocks between the first main blocks 30.

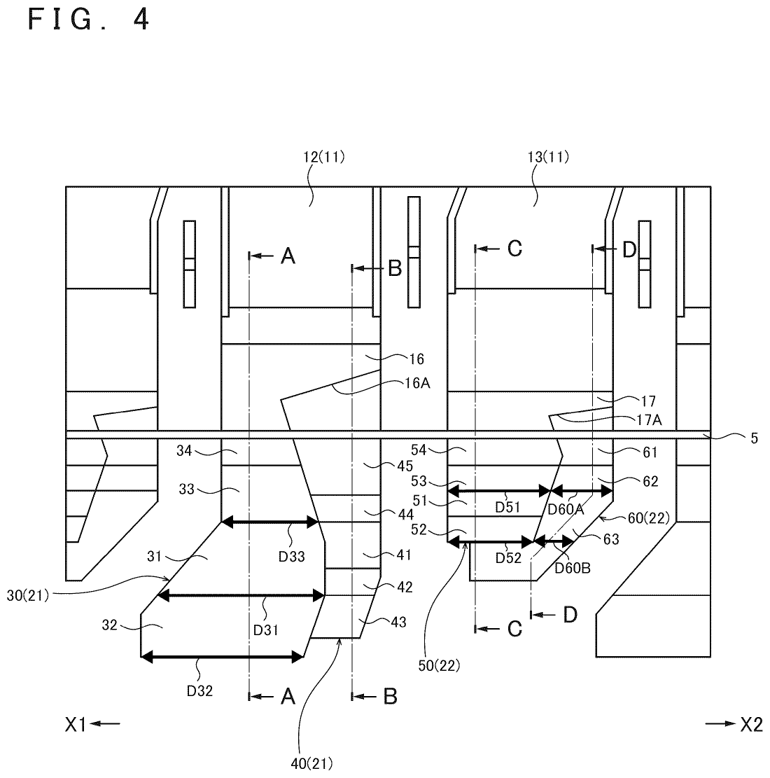

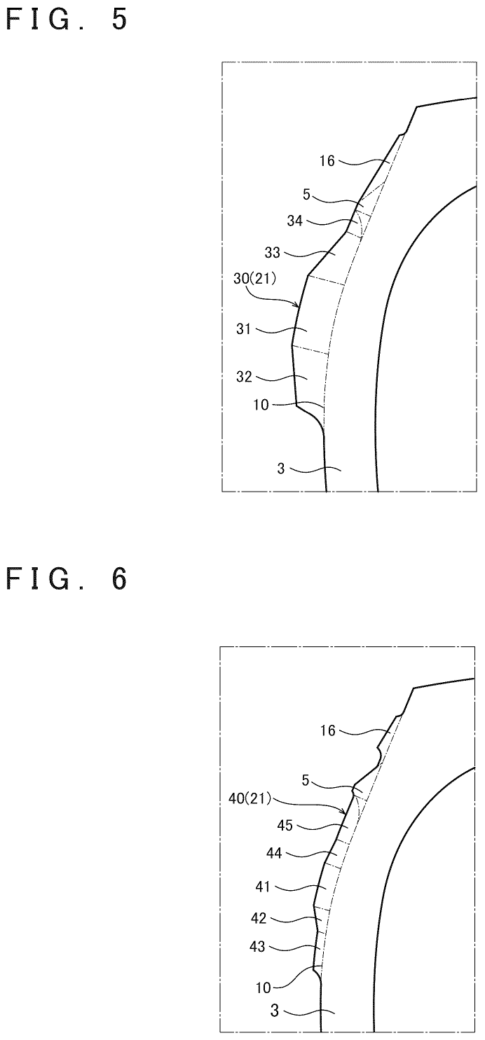

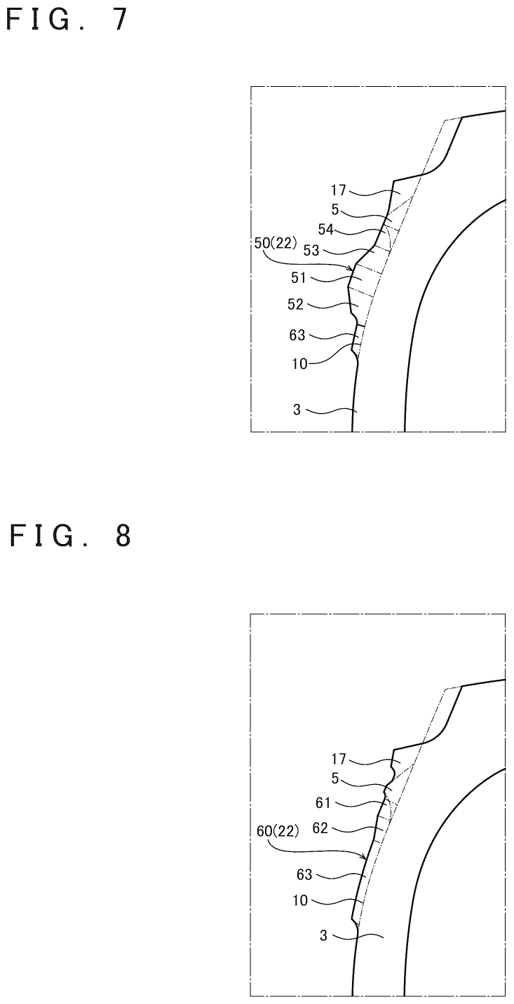

The first side block 21 and the second side block 22 will be described in detail below with reference to FIGS. 4 to 8. FIG. 4 is a projection drawing of the axially outer side of the pneumatic tire 1. FIG. 5 is a cross sectional view taken along line AA in FIG. 4. FIG. 6 is a cross sectional view taken along line BB in FIG. 4. FIG. 7 is a cross sectional view taken along line CC in FIG. 4. FIG. 8 is a cross sectional view taken along line DD in FIG. 4.

### First Side Block

As illustrated in FIG. 4, the first main block 30 forming the first side block 21 extends in the tire radial direction and includes the radially inward region that protrudes in the X1 direction.

The circumferential block edge of the first main block 30 on the X1 side extends substantially linearly along the tire radial direction in a front view, in a radially outward portion. The block edge of the first main block 30 on the X1 side has a bending point at an intermediate portion of the first main block 30 in the tire radial direction. The block edge of the first main block 30 on the X1 side extends substantially linearly along a direction that is inclined with respect to the tire radial direction in a front view, in a portion located further toward the Y2 direction with respect to the bending point. The block edge of the first main block 30 on the X1 side may have an angle of inclination of 20° or greater and 70° or less, or 30° or greater and 60° or less, for example, with respect to the tire radial direction. The block edge of the first main block 30 on the X1 side having a shape along the inclined direction toward the X1 direction with respect to tire radial direction enables the first main block 30 to easily catch mud and rocks during travel on muddy and sandy tracks. This configuration achieves higher traction performance.

The block edge of the first main block 30 on the X1 side again extends substantially linearly along the tire radial direction in a front view in a region of the first main block 30 in a region adjacent to a radially outward edge. The shape of the first main block 30 is not limited to the above example.

The block edge of the first main block 30 on a circumferential side toward the X2 direction, which will be referred to as an “X2 side”, is formed to protrude in the X2 direction in an intermediate portion of the first main block 30 in the tire radial direction in a front view. As such, the edge of the first main block 30 on the X2 side is located at the intermediate portion of the first main block 30 in the tire radial direction.

As illustrated in FIGS. 4 and 5, the first main block 30 includes, in the intermediate portion in the tire radial direction, a protrusion region (first protrusion region) 31 having the largest protrusion height in the first main block 30. The first main block 30 further includes, on a side of the protrusion region 31 in the Y2 direction, an inner inclination region (first inner inclination region) 32 having a protrusion height that decreases as the inner inclination region 32 extends away from the protrusion region 31 in the tire radial direction. The first main block 30 further includes, on a side of the protrusion region 31 in the Y1 direction, an outer inclination region (first outer inclination region) 33 having a protrusion height that decreases as the outer inclination region 33 extends away from the protrusion region 31 in the tire radial direction, and an outer even region 34 having a substantially uniform protrusion height. Thus, the first main block 30 includes, sequentially from the radially outward edge toward the radially inward edge of the first main block 30, the outer even region 34, the outer inclination region 33, the protrusion region 31, and the inner inclination region 32. In the present specification, the “protrusion height” of the block refers to a length from the profile line 10 along the normal of the profile line 10.

The protrusion region 31 has substantially the largest protrusion height in the first main block 30. The protrusion height of the protrusion region 31 is substantially uniform over the entire region of the protrusion region 31. The protrusion region 31 having the largest protrusion height in the first main block 30 easily catches mud and stones during travel on muddy or sandy tracks and easily catches rocks during travel on rocky tracts. Thus, the protrusion region 31 enables achieving of higher traction performance.

The protrusion height of the protrusion region 31 is larger than the maximum protrusion height of the first buttress block 16. Therefore, the maximum protrusion height of the first main block 30 is larger than the maximum protrusion height of the first buttress block 16. The protrusion height of the protrusion region 31 that is greater than the maximum protrusion height of the first buttress block 16 enables achieving of high traction performance. In the present embodiment, the first buttress block 16 has an increasing protrusion height as the first buttress block 16 extends further in the Y2 direction, and has the maximum protrusion height at a radially inward edge.

The protrusion height of the protrusion region 31 is 5 mm or greater, for example, and may be 7 mm or greater. This configuration enables the protrusion region 31 to catch mud, stones, and rocks more easily, thereby achieving higher traction performance. The protrusion height of the protrusion region 31 is 20 mm or less, for example, and may be 18 mm or less. This configuration facilitates a reduction in the air resistance. Therefore, the protrusion height of the protrusion region 31 is 5 mm or greater and 20 mm or less, for example, and may be 7 mm or greater and 18 mm or less.

The inner inclination region 32 is connected with the radially inward edge of the protrusion region 31. The protrusion height of the inner inclination region 32 decreases linearly as the inner inclination region 32 extends away from the protrusion region 31. The inner inclination region 32 disposed on the radially inward side of the protrusion region 31 reinforces the region of the protrusion region 31 near the radially inward edge to thereby reduce occurrence of chipping in the region of the protrusion region 31 near the radially inward edge.

The outer inclination region 33 is connected with the radially outward edge of the protrusion region 31. The outer inclination region 33, similar to the inner inclination region 32, has a protrusion height that decreases linearly as the outer inclination region 33 extends away from the protrusion region 31, for example.

The outer even region 34 is connected with the radially outward edge of the outer inclination region 33. The radially outward edge of the outer even region 34 constitutes the radially outward edge of the first main block 30, and is connected with the side rib 5. The protrusion height of the outer even region 34 is 80% or less of the protrusion height of the protrusion region 31, for example, and may be 60% or less of the protrusion height of the protrusion region 31. The radial length of the outer even region 34 is 5% or more and 30% or less of the radial length of the first main block 30, and may be 5% or more and 20% or less of the radial length of the first main block 30. The first main block 30 may have a configuration without the outer even region 34. In this configuration, the radially outward edge of the outer inclination region 33 direction is connected with the side rib 5.

As illustrated in FIG. 4, the maximum length (D31) of the protrusion region 31 in the tire circumferential direction, which will be referred to as the circumferential length, is larger than the circumferential length (D32) of the inner inclination region 32 at the radially inward edge. As described above, the protrusion region 31 protrudes the most in the first main block 30 and therefore easily catches rocks during travel on rocky tracts, thereby achieving high traction performance during travel on rocky tracts. Meanwhile, the protrusion region 31, which catches rocks easily, is likely to suffer chipping. Chipping that occurs in the protrusion region 31 makes it difficult for the protrusion region 31 to catch rocks, thereby deteriorating the traction performance. In particular, chipping tends to occur near the radially inward edge of the protrusion region 31.

The maximum circumferential length (D31) of the protrusion region 31 that is larger than the circumferential length (D32) of the inner inclination region 32 at the radially inward edge increases the strength of the protrusion region 31 to thereby further reduce chipping of the protrusion region 31. This configuration enables high traction performance to be maintained.

In the present embodiment, the circumferential length of the protrusion region 31 increases as the protrusion region 31 extends further toward the Y2 direction, and is the maximum at the radially inward edge of the protrusion region 31. As such, the maximum circumferential length (D31) of the protrusion region 31 corresponds to the circumferential length of the protrusion region 31 at the radially inward edge of the protrusion region 31. The radially inward portion of the protrusion region 31 is more likely to suffer chipping than the radially outward portion of the protrusion region 31. Therefore, the circumferential length of the protrusion region 31 that increases as the protrusion region 31 extends further toward the Y2 direction reduces occurrence of chipping in the radially inward portion of the protrusion region 31, thereby maintaining high traction performance.

The maximum circumferential length (D31) of the protrusion region 31 may be 1.05 times or more, or 1.1 times or more, of the circumferential length (D32) of the inner inclination region 32 at the radially inward edge. This configuration enables an increase in the strength of the protrusion region 31. The upper limit of the maximum circumferential length (D31) of the protrusion region 31 is, for example, twice the circumferential length (D32) of the inner inclination region 32 at the radially inward edge.

The maximum circumferential length (D31) of the protrusion region 31 may be larger than the maximum circumferential length (D33) of the outer inclination region 33. The maximum circumferential length (D31) of the protrusion region 31 that is larger than the maximum circumferential length (D33) of the outer inclination region 33 reduces occurrence of chipping in the protrusion region 31, thereby maintaining high traction performance. In the present embodiment, the circumferential length of the outer inclination region 33 increases as the outer inclination region 33 extends further in the Y2 direction, and is the maximum at the radially inward edge of the outer inclination region 33. As such, the maximum circumferential length (D33) of the outer inclination region 33 corresponds to the circumferential length of the outer inclination region 33 at the radially inward edge.

The maximum circumferential length (D31) of the protrusion region 31 may be 1.1 times or more, or 1.2 times or more, of the maximum circumferential length (D33) of the outer inclination region 33. This configuration enables an increase in the strength of the protrusion region 31. The upper limit of the maximum circumferential length (D31) of the protrusion region 31 is, for example, three times the maximum circumferential length (D33) of the outer inclination region 33.

Further, the radial length of the protrusion region 31 may be larger than the radial length of the inner inclination region 32. In the present embodiment, the radial length of each region, including each block, refers to a length along the tire radial direction from the radially outward edge to the radially inward edge of the region in a front view, unless otherwise specified.

The radial length of the protrusion region 31 that is larger than the radial length of the inner inclination region 32 enables the protrusion region 31 to easily catch stones and rocks during travel on sandy ground or rocky tracts, for example. This results in achieving of high traction performance.

The radial length of the protrusion region 31 may be 1.1 times or more and 3.0 times or less, or 1.2 times or more and 2.5 times or less, of the radial length of the inner inclination region 32. This configuration facilitates achievement of high traction performance.

The radial length of the protrusion region 31 is 20% or more and 80% or less, for example, of the radial length of the first main block 30, and may be 30% or more and 70% or less of the radial length of the first main block 30. This configuration further facilitates achievement of high traction performance.

The radial length of the inner inclination region 32 is 10% or more and 40% or less, for example, of the radial length of the first main block 30, and may be 15% or more and 35% or less of the radial length of the first main block 30. This configuration further reduces chipping in a radially inward portion of the protrusion region 31.

The radial length of the protrusion region 31 may be larger than the radial length of the outer inclination region 33. The radial length of the protrusion region 31 that is larger than the radial length of the outer inclination region 33 enables the protrusion region 31 to easily catch stones and rocks during travel on sandy ground or rocky tracts, for example. This results in achievement of high traction performance. The radial length of the protrusion region 31 may be 1.1 times or more and 3.0 times or less, or 1.2 times or more and 2.5 times or less, of the radial length of the outer inclination region 33. This configuration facilitates achievement of high traction performance. The radial length of the outer inclination region 33 is 10% or more and 40% or less, for example, of the tire radial length of the first main block 30, and may be 15% or more and 35% or less of the tire radial length of the first main block 30. This configuration further reduces chipping of the protrusion region 31.

The first main block 30 may be disposed such that the radially inward edge of the inner inclination region 32, which is the radially inward edge of the first main block 30, is not aligned with the tire maximum width location. In the present embodiment, the edge of the first main block 30 is disposed further toward the Y2 direction with respect to the tire maximum width location. The “tire maximum width location” as used herein refers to a location where the tire axial length is the maximum in a profile face of the side wall 3. The “profile face” of the side wall 3 as used herein refers to a top face of the side wall 3 facing axially outward where the side blocks 20 are not formed.

The tire maximum width location is likely to receive load during travel. Therefore, disposing the radially inward edge of the inner inclination region 32 so as not to be aligned with the tire maximum width location reduces damages such as cracks of the side wall 3. In other words, in the configuration having the radially inward edge of the inner inclination region 32 aligned with the tire maximum width location, the side wall 3 is unlikely to be bent in the vicinity of the tire maximum width location, making it likely to cause damage such as cracks, for example, in the side wall 3.

Further, the edge of the first main block 30 is disposed so as not to be aligned with the tire maximum width location and is also disposed within the length range corresponding to 20% of the tire sectional height H with respect to the tire maximum width location being as a center. This configuration enables further reduction of damage such as cracks of the side wall 3 while achieving high traction performance.

When the radially inward edge of the inner inclination region 32 is disposed further toward the Y1 direction beyond the above-described range, the radial length of the first main block 30 is reduced to make the first main block 30 unlikely to catch mud and stones during travel on muddy or sandy tracks. This makes it difficult to achieve high traction performance. Meanwhile, when the radially inward edge of the inner inclination region 32 is disposed further in the Y2 direction beyond the above-described range, the side wall 3 is unlikely to be bent, causing damages such as cracks in a portion of the side wall 3 where the side blocks 20 are not formed.

As illustrated in FIG. 4, the first sub block 40 that forms the first side block 21 is disposed on a first side of the first main block 30 in the circumferential X2 direction, and has a maximum protrusion height that is smaller than the maximum protrusion height of the first main block 30. The first sub block 40 extends in the tire radial direction and has a circumferential length that decreases as the first sub block 40 extends further in the Y2 direction. The circumferential length of the first sub block 40 at the radially inward edge is 10% or more and 50% or less, for example, and may be 20% or more and 40% or less, of the circumferential length (D32) of the first main block 30 at the radially inward edge of the first main block 30.

The radially inward edge of the first sub block 40 may be disposed further toward the Y2 direction with respect to the radially inward edge of the protrusion region 31 of the first main block 30. Thus, the first sub block 40 may be disposed such that the first sub block 40 is aligned with the entire region of the protrusion region 31 of the first main block 30 in the tire circumferential direction. As described above, the radially inward edge of the protrusion region 31 is likely to suffer chipping during travel. Therefore, the radially inward edge of the first sub block 40 that is disposed further in the Y2 direction with respect to the radially inward edge of the protrusion region 31 reduces occurrence of chipping at the radially inward edge of the protrusion region 31. This results in maintaining of high traction performance.

In the present embodiment, the radially inward edge of the first sub block 40 is disposed further in the Y1 direction with respect to the radially inward edge of the inner inclination region 32 of the first main block 30. As such, the radial length of the first sub block 40 is smaller than the radial length of the first main block 30. The radially inward edge of the first sub block 40 may be disposed at a location which is aligned with the radially inward edge of the inner inclination region 32 in the tire circumferential direction, or disposed further in the Y2 direction with respect to the radially inward edge of the inner inclination region 32.

As illustrated in FIGS. 4 and 6, in the present embodiment, the first sub block 40 includes, in the intermediate portion in the tire radial direction, a protrusion region (second protrusion region) 41 having the largest protrusion height in the first sub block 40. The first sub block 40 further includes, on the radially inward side of the protrusion region 41, an inner inclination region (second inner inclination region) 42 having a protrusion height that gradually decreases as the second inner inclination region 42 extends away from the protrusion region 41, and an inner even region 43 having a substantially uniform protrusion height. The first sub block 40 further includes, on the radially outward side of the protrusion region 41, an outer inclination region (second outer inclination region) 44 having a protrusion height that gradually decreases as the second outer inclination region 44 extends away from the protrusion region 41, and an outer even region 45 having a substantially uniform protrusion height. The first sub block 40 thus sequentially includes, from the radially outward edge of the first sub block 40 toward the radially inward edge of the first sub block 40, the outer even region 45, the outer inclination region 44, the protrusion region 41, the inner inclination region 42, and the inner even region 43.

The shape of the first sub block 40 is not limited to the above example. For example, the first sub block 40 may have a uniform thickness over the entire region in the tire radial direction. However, the first sub block 40 including the protrusion region 41, the inner inclination region 42, and the outer inclination region 44 tends to reduce occurrence of chipping in the first sub block 40, facilitating an increase in the strength and durability of the first main block 30.

The protrusion region 41 has substantially the largest protrusion height in the first sub block 40. The protrusion height of the protrusion region 41 is substantially uniform over the entire protrusion region 41. The protrusion height of the protrusion region 41 is 20% or more and 70% or less, for example, of the protrusion height of the protrusion region 31 of the first main block 30, and may be 30% or more and 60% or less of the protrusion height of the protrusion region 31.

The protrusion region 41 is disposed at a location that is aligned with the protrusion region 31 of the first main block 30 in the tire circumferential direction. This configuration enables further reduction in occurrence of chipping in the protrusion region 31 of the first main block 30, which makes it possible to maintain high traction performance. In the present embodiment, the radially outward edge of the protrusion region 41 is disposed at a location that is aligned with the radially outward edge of the protrusion region 31 of the first main block 30 in the tire circumferential direction. The radially inward edge of the protrusion region 41 is disposed further in the Y1 direction with respect to the radially inward edge of the protrusion region 31 of the first main block 30. The radial length of the protrusion region 41 is therefore smaller than the radial length of the protrusion region 31 of the first main block 30.

The inner inclination region 42 is connected with the radially inward edge of the protrusion region 41. The inner inclination region 42 has a protrusion height that linearly decreases as the inner inclination region 42 extends away from the protrusion region 41, for example. In the present embodiment, the radially inward edge of the inner inclination region 42 is disposed at a location that is aligned with the radially inward edge of the protrusion region 31 of the first main block 30 in the tire circumferential direction. Thus, the sum of the radial length of the protrusion region 41 and the radial length of the inner inclination region 42 is substantially equal to the radial length of the protrusion region 31 of the first main block 30.

The inner even region 43 is connected with the radially inward edge of the inner inclination region 42. The inner even region 43 has a protrusion height that is, for example, 80% or less of the protrusion height of the protrusion region 41, or that may be 60% or less of the protrusion height of the protrusion region 41. As described above, the radially inward edge of the inner even region 43 is disposed further in the Y1 direction with respect to the radially inward edge of the inner inclination region 32 of the first main block 30.

The outer inclination region 44 is connected with the radially outward edge of the protrusion region 41. The outer inclination region 44, similar to the inner inclination region 42, for example, has a protrusion height that decreases linearly as the outer inclination region 44 extends away from the protrusion region 41. In the present embodiment, the radially outward edge of the outer inclination region 44 is disposed further in the Y2 direction with respect to the radially outward edge of the outer inclination region 33 of the first main block 30.

The outer even region 45 is connected with the radially outward edge of the outer inclination region 44. The outer even region 45 has a protrusion height that is, for example, 80% or less of the protrusion height of the protrusion region 41, or a protrusion height that may be 60% or less of the protrusion height of the protrusion region 41. The protrusion height of the outer even region 45 may be the same as or different from the protrusion height of the inner even region 43. In the present embodiment, the protrusion height of the outer even region 45 is larger than the protrusion height of the inner even region 43.

The radial length of the protrusion region 41 may be larger than the radial length of the inner inclination region 42 and the radial length of the outer inclination region 44. This configuration facilitates an increase in the strength and durability of the first main block 30.

The radial length of the protrusion region 41 is 5% or more and 50% or less, for example, of the radial length of the first sub block 40 and may be 10% or more and 40% or less of the radial length of the first sub block 40. The radial length of the protrusion region 41 is 1.1 times or more and 3.0 times or less, for example, of the radial length of the inner inclination region 42 and the radial length of the outer inclination region 44, and may be 1.2 times or more and 2.5 times or less of the radial length of the inner inclination region 42 and the radial length of the outer inclination region 44.

The radial length of the inner inclination region 42 and the radial length of the outer inclination region 44 are, for example, 10% or more and 40% or less, and may be 15% or more and 35% or less, of the radial length of the first sub block 40. This configuration further enables reduction in chipping of the protrusion region 41.

### Second Side Block

As illustrated in FIG. 4, the second main block 50 forming the second side block 22 extends in the tire radial direction, and has a length in the tire circumferential direction (hereinafter referred to as a “circumferential length”) that decreases as the second main block 50 extends in the Y2 direction.

As illustrated in FIG. 4, the projected area of the second main block 50 is smaller than the projected area of the first main block 30. In other words, the projected area of the first main block 30 is larger than the projected area of the second main block 50. The first main block 30 having a larger projected area allows the first main block 30 to easily catch stones and rocks during travel on sandy and rocky tracks, for example, thereby achieving high traction performance. The second main block 50 having a smaller projected area enables creation of a greater region where the second main block 50 is not disposed between the first main blocks 30 adjacent to each other in the tire circumferential direction This configuration allows such a region to easily catch rocks, resulting in achieving of higher traction performance during travel on rocky tracts. In the present embodiment, the projected area of each of the first main block 30 and the second main block 50 refers to an area inside the contour line of the top face of the first main block 30 and the second main block 50, respectively, in a front view.

The circumferential block edge of the second main block 50 on the X1 side is linearly formed in a front view along the tire radial direction. The circumferential block edge of the second main block 50 on the X2 side is linearly formed in a front view along a direction that is inclined toward the X1 direction with respect to the tire radial direction. The angle of inclination of the circumferential block edge of the second main block 50 on the X2 side with respect to the tire radial direction is 10° or larger and 60° or less, for example, and may be 20° or larger and 50° or less.

As illustrated in FIGS. 4 and 7, the second main block 50, similar to the first main block 30, includes, in the intermediate portion in the tire radial direction, a protrusion region 51 having the largest protrusion height in the second main block 50. The second main block 50 further includes, on the radially inward side of the protrusion region 51, an inner inclination region 52 having a gradually decreasing protrusion height as the inner inclination region 52 extends away from the protrusion region 51 in the tire radial direction. The second main block 50 further includes, on the radially outward side of the protrusion region 51, an outer inclination region 53 having a gradually decreasing protrusion height as the outer inclination region 53 extends away from the protrusion region 51 in the tire radial direction, and an outer even region 54 having a substantially uniform protrusion height. Thus, the second main block 50 includes, sequentially from the radially outward edge of the second main block 50 to the radially inward edge of the second main block 50, the outer even region 54, the outer inclination region 53, the protrusion region 51, and the inner inclination region 52.

The protrusion region 51 has substantially the largest protrusion height in the second main block 50. The protrusion height of the protrusion region 51 of the second main block 50 is smaller than the protrusion height of the protrusion region 31 of the first main block 30. The protrusion height of the protrusion region 51 of the second main block 50 is substantially uniform over the entire region of the protrusion region 51. The protrusion region 51, similar to the protrusion region 31 of the first main block 30, easily catches mud and stones during travel on muddy or sandy tracks, and easily catches rocks during travel on rocky tracts. Thus, the protrusion region 51 enables achieving of higher traction performance.

The protrusion height of the protrusion region 51 is 4 mm or greater, for example, and may be 6 mm or greater. This configuration enables the protrusion region 51 to catch mud, stones, and rocks more easily, thereby achieving higher traction performance. The protrusion height of the protrusion region 51 is 20 mm or less, for example, and may be 18 mm or less. This configuration facilitates a reduction in the air resistance of the tire. Therefore, the protrusion height of the protrusion region 51 is 4 mm or greater and 20 mm or less, for example, and may be 6 mm or greater and 18 mm or less.

The inner inclination region 52 is connected with the radially inward edge of the protrusion region 51. The protrusion height of the inner inclination region 52 decreases linearly as the inner inclination region 52 extends away from the protrusion region 51.

The outer inclination region 53 is connected with the radially outward edge of the protrusion region 51. The outer inclination region 53, similar to the inner inclination region 52, has a protrusion height that decreases linearly as the outer inclination region 53 extends away from the protrusion region 51, for example.

The outer even region 54 is connected with the radially outward edge of the outer inclination region 53. The radially outward edge of the outer even region 54 constitutes the radially outward edge of the second main block 50, and is connected with the side rib 5. The protrusion height of the outer even region 54 is 80% or less of the protrusion height of the protrusion region 51, for example, and may be 60% or less of the protrusion height of the protrusion region 51. The radial length of the outer even region 54 is 5% or more and 30% or less of the radial length of the second main block 50, and may be 5% or more and 20% or less of the radial length of the second main block 50. The second main block 50 may have a configuration without the outer even region 54. In this configuration, the radially outward edge of the outer inclination region 53 is connected with the side rib 5.

The maximum circumferential length (D51) of the protrusion region 51 is larger than the circumferential length (D52) of the inner inclination region 52 at the radially inward edge. As described above, the protrusion region 51 protrudes the furthest in the second main block 50 and therefore easily catches rocks during travel on rocky tracts, which makes it likely for the protrusion region 51 to suffer chipping. Chipping that occurs in the protrusion region 51 makes it difficult for the protrusion region 51 to catch rocks, thereby deteriorating the traction performance.

The maximum circumferential length (D51) of the protrusion region 51 that is larger than the circumferential length (D52) of the inner inclination region 52 at the radially inward edge increases the strength of the protrusion region 51 to thereby further reduce chipping of the protrusion region 51. This configuration maintains high traction performance. In the present embodiment, the circumferential length of the protrusion region 51 increases as the protrusion region 51 extends in the Y1 direction and reaches the maximum at the radially outward edge of the protrusion region 51.

The maximum circumferential length (D51) of the protrusion region 51 may be 1.05 times or more, or 1.1 times or more, of the circumferential length (D52) of the inner inclination region 52 at the radially inward edge. This configuration increases the strength of the protrusion region 51. The upper limit of the maximum circumferential length (D51) of the protrusion region 51 is, for example, twice the circumferential length (D52) of the inner inclination region 52 at the radially inward edge.

Further, the radial length of the protrusion region 51 may be equal to or larger than the radial length of the inner inclination region 52. The radial length of the protrusion region 51 that is larger than the radial length of the inner inclination region 52 enables the protrusion region 51 to easily catch stones and rocks during travel on sandy ground or rocky tracts, for example. This results in achieving of high traction performance.

The radial length of the protrusion region 51 is 20% or more and 80% or less, for example, of the radial length of the second main block 50, and may be 30% or more and 70% or less of the radial length of the second main block 50. This configuration further facilitates achievement of high traction performance.

The radial length of the inner inclination region 52 is 10% or more and 40% or less, for example, of the radial length of the second main block 50, and may be 15% or more and 35% or less of the radial length of the second main block 50. This configuration further reduces occurrence of chipping in the radially inward portion of the protrusion region 51.

As illustrated in FIG. 4, the second sub block 60 forming the second side block 22 is disposed on a circumferentially X2 side of the second main block 50, and has a protrusion height that is smaller than the protrusion height of the second main block 50.

The second sub block 60 has a radially inward edge that is disposed further in the Y2 direction with respect to the radially inward edge of the second main block 50. Thus, the radial length of the second sub block 60 is larger than the radial length of the second main block 50. This configuration allows the second sub block 60 to be connected with the entire region of a circumferential block edge of the second main block 50 toward the X2 direction, and most of the radially inward edge of the second main block 50.

A portion of the second main block 50 located adjacent to the radially inward edge is likely to cause chipping during travel. In particular, when the radial length of the second main block 50 is smaller than the radial length of the first main block 30, as in the present embodiment, a region of the tire on the radially inward side of the second main block 50 is likely to be hit by rocks during travel on rocky tracts. This results in occurrence of chipping in the portion of the second main block 50 adjacent to the radially inward edge during traveling on rocky tracts. Occurrence of such chipping in a region of the second main block 50 adjacent to the radially inward edge can be reduced with the configuration of the second sub block 60 having the radially inward edge disposed further in the Y2 direction with respect to the radially inward edge of the second main block 50 and the configuration of the second sub block 60 connected with most part of the radially inward edge of the second main block 50.

As illustrated in FIG. 8, in the present embodiment, the second sub block 60 includes a protrusion region 61 having the largest protrusion height of the second sub block 60 in a radially outward portion. The second sub block 60 further includes, on a radially inward side of the protrusion region 61, an inner inclination region 62 having a decreasing protrusion height as the inner inclination region 62 extends away from the protrusion region 61, and an inner even region 63 having a substantially uniform protrusion height. Thus, the second sub block 60 sequentially includes, from the radially outward end of the second sub block 60 toward the radially inward end of the second sub block 60, the protrusion region 61, the inner inclination region 62, and the inner even region 63.

The shape of the second sub block 60 is not limited to the above example, and the second sub block 60 may have substantially uniform thickness over the entire region along the tire radial direction, for example. The second sub block 60, similar to the first sub block 40, may further include, on the radially outward side of the protrusion region 61, an outer inclination region having a protrusion height that gradually decreases as the outer inclination region extends away from the protrusion region 61.

The protrusion region 61 has substantially the largest protrusion height in the second sub block 60. The protrusion height of the protrusion region 61 is substantially uniform over the entire protrusion region 61. The protrusion height of the protrusion region 61 is 20% or more and 70% or less, for example, of the protrusion height of the protrusion region 51 of the second main block 50, and may be 30% or more and 60% or less of the protrusion height of the protrusion region 51.

The protrusion region 61 is disposed at a location that is aligned with the outer even region 54 of the second main block 50 in the tire circumferential direction. The radially outward edge of the protrusion region 61 forms the radially outward edge of the second sub block 60 and is connected with the side rib 5. The protrusion region 31 (61?) may be partially disposed at a location where the protrusion region 31 (61?) is circumferentially aligned with the outer inclination region 53 or the protrusion region 51 of the second main block 50.

The inner inclination region 62 is connected with the radially inward edge of the protrusion region 61. The inner inclination region 62 may have a protrusion height that linearly decreases as the inner inclination region 62 extends away from the protrusion region 61, for example. In the present embodiment, the inner inclination region 62 is disposed at a location where the inner inclination region 62 is aligned with the outer inclination region 53 of the second main block 50 in the tire circumferential direction. The inner even region 63 (inner inclination region 62??) may be partially disposed at a location where the inner inclination region 62(??) is circumferentially aligned with the outer even region 54 or the protrusion region 51 of the second main block 50 in the tire circumferential direction.

In the present embodiment, the radial length of the protrusion region 61 is substantially the same as the radial length of the inner inclination region 62. However, the radial length of the protrusion region 61 may be larger than the radial length of the inner inclination region 62. The radial length of the protrusion region 61 is 10% or more and 50% or less of the radial length of the second sub block 60, for example, and may be 15% or more and 40% or less of the radial length of the second sub block 60.

The inner even region 63 is connected with the radially inward edge of the inner inclination region 62. The protrusion height of the inner even region 63 is 80% or less of the protrusion height of the protrusion region 61, for example, and may be 60% or less.

The inner even region 63 has a shape, in a radially inward portion, which is bent in the X1 direction. The radially outward portion of the inner even region 63 is connected with the circumferential block edge of the second main block 50 on the X2 side. The radially inward portion of the inner even region 63 is also connected with the radially inward block edge of the second main block 50. This configuration reduces occurrence of chipping in the vicinity of the radially inward edge of the second main block 50.

The second sub block 60 may be configured such that a portion of the second sub block 60 that is circumferentially aligned with the protrusion region 51 of the second main block 50 has an increased circumferential length. Specifically, the ratio X (D60A/D51) of the circumferential length (D60A) of the second sub block 60 relative to the circumferential length (D51) of the protrusion region 51 at a location where the circumferential length of the protrusion region 51 is the maximum, which is at the radially outward edge of the protrusion region 51 in the present embodiment, is larger than the ratio Y (D60B/D52) of the circumferential length (D60B) of the second sub block 60 relative to the circumferential length (D52) of the second main block 50 at the radially inward edge of the second main block 50. A result of study performed by the present inventors revealed that the configuration having the ratio X that is larger than the ratio Y further reduces chipping in the second main block 50 to thereby maintain high traction performance.

The ratio X may be 1.1 times or more of the ratio Y, and may be 1.2 times or more. This configuration further reduces chipping in the second main block 50.

As described above, the pneumatic tire 1 according to the present embodiment includes, on the side wall 3, the first side block 21 and the second side block 22. The first side block 21 includes the first main block 30 extending in the tire radial direction, and the second side block 22 includes the second main block 50 extending in the tire radial direction. The maximum protrusion height of the first main block 30 is larger than the maximum protrusion height of the second main block 50, and the radial length of the first main block 30 is larger than the radial length of the second main block 50.

This configuration allows formation of a region where the second main block 50 is not disposed between the first main blocks 30 adjacent to each other in the tire circumferential direction, in the radially inward portion of the first main block 30. This region is likely to catch rocks easily during travel on rocky tracts. Thus, this configuration achieves high traction performance during traveling on rocky tracts.

The pneumatic tire 1 according to the present embodiment includes, on the side wall 3, the first side block 21 and the second side block 22. The first side block 21 includes the first main block 30 extending in the tire radial direction, and the second side block 22 includes the second main block 50 extending in the tire radial direction. The first main block 30 and the second main block 50 respectively include the protrusion regions 31 and 51 each having the largest protrusion height in each main block, and the inner inclination regions 32 and 52 connected with the radially inward edges of the protrusion region 31 and the protrusion region 51, respectively, and having protrusion heights that gradually decrease as the respective inner inclination regions extend away from the protrusion regions 31 and 51, respectively. The protrusion regions 31 and 51 each have the maximum circumferential lengths that are equal to or larger than the circumferential lengths of the radially inward edges of the respective inner inclination regions 32 and 52.

This configuration enables the protrusion regions 31 and 51 to easily catch mud, stones, and rocks during travel on muddy and sandy ground or rocky tracts, thereby achieving high traction performance. Meanwhile, chipping is likely to occur in the protrusion regions 31 and 51 of the first main block 30 and the second main block 50, respectively, especially during travel on rocky tracts. However, the above configuration enables reduction in occurrence of chipping in the protrusion regions 31 and 51 to thereby maintain high traction performance.

The pneumatic tire 1 according to the present embodiment includes, on the side wall 3, the first side block 21 and the second side block 22. The first side block 21 includes the first main block 30 extending in the tire radial direction, and the second side block 22 includes the second main block 50 extending in the tire radial direction. The first main block 30 and the second main block 50 respectively include the protrusion regions 31 and 51 each having the largest protrusion height in each main block, and the inner inclination regions 32 and 52 connected with the radially inward edges of the protrusion region 31 and the protrusion region 51, respectively, and having protrusion heights that gradually decrease as the respective inner inclination regions extend away from the protrusion regions 31 and 51, respectively. The radial lengths of the protrusion regions 31 and 51 are equal to or larger than the radial lengths of the inner inclination regions 32 and 52, respectively.

This configuration enables the protrusion regions 31 and 51 to easily catch mud, stones, and rocks during travel on muddy and sandy ground or rocky tracts, thereby achieving high traction performance. Further, the inner inclination regions 32 and 52 disposed on the radially inward sides of the protrusion regions 31 and 51, respectively, reduce occurrence of chipping in the regions on the radially inward side of the protrusion regions 31 and 51, respectively, where chipping is typically likely to occur. Thus, this configuration enables reduction in occurrence of chipping in the protrusion regions 31 and 51 while achieving high traction performance, thereby maintaining high traction performance.

The design of the above embodiment may be modified within the range of the object of the present disclosure. For example, while, in the above embodiment, the first side block 21 includes the first main block 30 and the first sub block 40, and the second side block 22 includes the second main block 50 and the second sub block 60, the configurations of the first side block 21 and the second side block 22 are not limited to this example. The first side block 21 may include only the first main block 30 and may not include the first sub block 40. Similarly, the second side block 22 may include only the second main block 50 and may not include the second sub block 60.

### REFERENCE SIGNS LIST

1 pneumatic tire, 2 tread, 2A, 2B, 2C circumferential groove, 3 side wall, 4 bead, 4A bead core, 4B bead filler, 5 side rib, 6 carcass, 7 inner liner, 8 belt, 8A, 8B belt ply, 9 cap ply, 10 profile line, 11 shoulder block, 12 first shoulder block, 12A side face, 12X corner, 13 second shoulder block, 13A side face, 14, 15 longitudinal groove, 16 first buttress block, 16A, 17A recess, 17 second buttress block, 20 side block, 21 first side block, 21A, 22A slope face, 22 second side block, 30 first main block, 31, 41, 51, 61 protrusion region, 32, 42, 52, 62 inner inclination region, 33, 44, 53 outer inclination region, 34, 45, 54 outer even region, 40 first sub block, 43, 63 inner even region, 50 second main block, 60 second sub block.

1. A pneumatic tire comprising a tread, a side wall, and a bead, wherein
the side wall includes side blocks protruding outward in a tire axial direction,
each side block includes at least a main block extending in a tire radial direction,
the main block includes:
a protrusion region having a largest protrusion height in the main block; and
an inner inclination region connected with an inward edge of the protrusion region in the tire radial direction, the inner inclination region having a protrusion height that gradually decreases as the inner inclination region extends away from the protrusion region; and
the protrusion region has a length in the tire radial direction, the length in the tire radial direction being equal to or larger than a length of the inner inclination region in the tire radial direction.

2. The pneumatic tire according to claim 1, wherein
the main block further includes an outer inclination region connected with an outward edge of the protrusion region in the tire radial direction, the outer inclination region having a protrusion height that gradually decreases as the outer inclination region extends away from the protrusion region, and
the protrusion region has a length in the tire radial direction, the length in the tire radial direction being equal to or larger than a length of the outer inclination region in the tire radial direction.

3. The pneumatic tire according to claim 1, wherein
the main block includes an inward edge portion in the tire radial direction, the inward edge portion protruding toward a first side along a tire circumferential direction.

4. The pneumatic tire according to claim 1, wherein
the length of the protrusion region in the tire radial direction is 20% or more and 80% or less of a length of the main block in the tire radial direction.

5. The pneumatic tire according to claim 1, wherein
the length of the inner inclination region in the tire radial direction is 10% or more and 40% or less of a length of the main block in the tire radial direction.

6. The pneumatic tire according to claim 1, wherein
the side blocks include a first side block and a second side block arranged alternately along the circumferential direction, and
the second side block has a length in the tire radial direction that is smaller than a length of the first side block in the tire radial direction.

7. The pneumatic tire according to claim 1, wherein
each side block further includes a sub block connected with the main block on a second side along a tire circumferential direction, the sub block having a protrusion height that is smaller than the protrusion height of the main block.

8. The pneumatic tire according to claim 7, wherein
the sub block has an inward edge in the tire radial direction, the inward edge located further inward in the tire radial direction relative to an inward edge of the protrusion region of the main block in the tire radial direction.

9. The pneumatic tire according to claim 1, wherein
the main block has an inward edge in the tire radial direction, the inward edge being disposed such that the inward edge is not aligned with a tire maximum width location.

10. The pneumatic tire according to claim 9, wherein
the inward edge of the main block in the tire radial direction is disposed within a length range corresponding to 20% of a tire sectional height with respect to the tire maximum width location as a center.

11. A pneumatic tire comprising a tread, a side wall, and a bead, wherein
the side wall includes side blocks protruding outward in a tire axial direction,
the side blocks include a first side block and a second side block alternately arranged in a tire circumferential direction,
the first side block includes at least a first main block extending in a tire radial direction,
the second side block includes at least a second main block extending in the tire radial direction,
the first main block has a maximum protrusion height that is larger than a maximum protrusion height of the second main block, and
the first main block has a length in the tire radial direction that is larger than a length of the second main block in the tire radial direction.

12. The pneumatic tire according to claim 11, wherein
the first side block includes a first sub block that is connected with the first main block on a first side along the tire circumferential direction, the first sub block having a maximum protrusion height that is smaller than the maximum protrusion height of the first main block, and
the second side block includes a second sub block that is connected with the second main block on the first side along the tire circumferential direction, the second sub block having a maximum protrusion height that is smaller than the maximum protrusion height of the second main block.

13. The pneumatic tire according to claim 11, wherein
the first main block has a projected area that is larger than a projected area of the second main block.

14. The pneumatic tire according to claim 11, comprising:
a side rib between the tread and the side wall, the side rib extending annularly along the tire circumferential direction; and
in a further outward region of the tire in the tire radial direction with respect to the side rib, a first buttress block connected with the first main block with the side rib being interposed between the first buttress block and the first main block and a second buttress block connected with the second main block with the side rib being interposed between the second buttress block and the second main block, wherein
the maximum protrusion height of the first main block is larger than a maximum protrusion height of the first buttress block, and
the maximum protrusion height of the second main block is larger than a maximum protrusion height of the second buttress block.

15. The pneumatic tire according to claim 11, wherein
the first main block has an inward edge portion in the tire radial direction, the inward edge portion protruding toward a second side along the tire circumferential direction, and
the first main block and the second main block are arranged such that the first main block and the second main block are not aligned with each other in the tire radial direction.

16. The pneumatic tire according to claim 11, wherein
the length of the first main block in the tire radial direction is 1.2 times or more and 3.0 times or less of the length of the second main block in the tire radial direction.

17. The pneumatic tire according to claim 11, wherein
the first main block includes:
a first protrusion region having a largest protrusion height in the first main block; and
a first inner inclination region connected with an inward edge of the first protrusion region in the tire radial direction, the first inner inclination region having a protrusion height that gradually decreases as the first inner inclination region extends away from the first protrusion region.

18. The pneumatic tire according to claim 17, wherein
the first protrusion region has a length in the tire radial direction that is larger than a length of the first inner inclination region in the tire radial direction.

19. The pneumatic tire according to claim 11, wherein
the second main block includes:
a second protrusion region having a largest protrusion height in the second main block; and
a second inner inclination region connected with an inward edge of the second protrusion region in the tire radial direction, the second inner inclination region having a protrusion height that gradually decreases as the second inner inclination region extends away from the second protrusion region.

20. The pneumatic tire according to claim 17, wherein
the first main block further comprises a first outer inclination region connected with an outward edge of the first protrusion region in the tire radial direction, the first outer inclination region having a protrusion height that gradually decreases as the first outer inclination region extends away from the first protrusion region.

21. The pneumatic tire according to claim 20, wherein
the first protrusion region has a length in the tire radial direction, the length being larger than a length of the first outer inclination region in the tire radial direction.

22. The pneumatic tire according to claim 19, wherein
the second main block further comprises a second outer inclination region connected with an outward edge of the second protrusion region in the tire radial direction, the second outer inclination region having a protrusion height that gradually decreases as the second outer inclination region extends away from the second protrusion region.

23. A pneumatic tire comprising a tread, a side wall, and a bead, wherein
the side wall includes side blocks protruding outward in a tire axial direction,
each side block includes at least a main block extending in a tire radial direction,
the main block includes:
a protrusion region having a largest protrusion height in the main block; and
an inner inclination region connected with an inward edge of the protrusion region in the tire radial direction, the inner inclination region having a protrusion height that gradually decreases as the inner inclination region extends away from the protrusion region, and
the protrusion region has a maximum length in a tire circumferential direction, the maximum length being larger than a length, in a tire circumferential direction, of an inward edge of the inner inclination region in the tire radial direction.

24. The pneumatic tire according to claim 23, wherein
the main block further includes an outer inclination region connected with an outward edge of the protrusion region in the tire radial direction, the outer inclination region having a protrusion height that gradually decreases as the outer inclination region extends away from the protrusion region, and
the maximum length of the protrusion region in the tire circumferential direction is larger than a maximum length of the outer inclination region in the tire circumferential direction.

25. The pneumatic tire according to claim 23, wherein
the side blocks comprise a first side block and a second side block that are alternately arranged along the tire circumferential direction,
the first side block includes a first main block and the second side block includes a second main block,
the first main block has a length in a tire radial direction that is larger than a length of the second main block in the tire radial direction.

26. The pneumatic tire according to claim 23, wherein
each side block further includes a sub block connected with the main block on a first side in the tire circumferential direction, the sub block having a maximum protrusion height that is smaller than a maximum protrusion height of the main block.

27. The pneumatic tire according to claim 25, wherein
the side blocks further include sub blocks each connected with the main block on a first side in the tire circumferential direction, the sub block having a maximum protrusion height that is smaller than a maximum protrusion height of the main block, and
the sub blocks include a first sub block connected with the first main block on the first side in the tire circumferential direction and a second sub block connected with the second main block on the first side in the tire circumferential direction.

28. The pneumatic tire according to claim 27, wherein
a ratio X of a length of the second sub block in the tire circumferential direction with respect to a length of the protrusion region of the second main block in the tire circumferential direction, at a location where the length of the protrusion region in the tire circumferential direction is the maximum, is larger than a ratio Y of the length of the second sub block in the tire circumferential direction with respect to the length of the second main block in the tire circumferential direction at an inward edge of the second main block in the tire radial direction.

29. The pneumatic tire according to claim 28, wherein
the ratio X is 1.1 times or more of the ratio Y.

30. The pneumatic tire according to claim 27, wherein
the second sub block has an inward edge in the tire radial direction that is located further inward in the tire radial direction relative to an inward edge of the second main block in the tire radial direction.

31. The pneumatic tire according to claim 23, wherein
the protrusion region has a length in the tire radial direction that is larger than a length of the inner inclination region in the tire radial direction.

32. The pneumatic tire according to claim 24, wherein
the protrusion region has a length in the tire radial direction that is larger than a length of the outer inclination region in the tire radial direction.
